(19) United States
(12) Patent Application Publication
(10) Pub. No.: US 2003/0145322 A1
(43) Pub. Date: Jul. 31, 2003

(54) Limiting apparatus of electric machinery

(76) Inventor: Chang Bin Song, Taejun (KR)

Correspondence Address: Peter T Kwon, Kangnam PO Box 2301, Seoul, 135-242, KR

(21) Appl. No.: 10/276,061

(22) PCT Filed: May 16, 2001
(86) PCT No.: PCT/KR01/00790

(30) Foreign Application Priority Data
May 17, 2000 (KR) 2000-13987 U

(51) Int. Cl. H04N 7/16

(52) U.S. Cl. 725/26; 725/29

(57) ABSTRACT

A device for limiting the use of electronic appliances is disclosed. A timer is set inside an electronic appliance such as a television or personal computer. A three-stage conversion switch capable of selecting one of the continuous use of the electronic appliance, the use of the appliance for a period of time set by the timer, and suspension of the use of the appliance. In case of the selection of timer mode, the electronic appliance can be used only for a predetermined period of time set by the timer. During a period of time other than the set time, the electronic appliance may be continuously used or its operation is stopped according to a selected mode. A warning means warns that the end of the time set by the timer is approaching before the completion of the set time.

### TECHNICAL FIELD

The present invention relates to a device for limiting the use of home electronic appliances such as a television and computer, which allows users to be able to use the electronic appliances only for a predetermined period of time in order to prevent children from indiscreetly using the appliances.

### BACKGROUND ART

Home electronic appliances such as a personal computer and television are important means for providing a vast amount of information and entertainment, but they can adversely affect their users when the users use them indiscreetly and excessively. Especially, children or juveniles can be badly influenced educationally and emotionally and deteriorate their eyesight when they spend excessive time for computer games or watching television. Accordingly, it is required to limit the use of the appliances.

A certain conventional television or personal computer has a key lock function for limiting the operation of the electronic appliance using a key to prevent its user from excessively using it, or a password input function for driving the appliance only when a predetermined password is inputted. However, these functions are nothing but control means for forcibly restricting the use of the electronic appliance or security means. Furthermore, there is no method or device for appropriately controlling the electronic appliances to allow their users to be able to use them restrictively. It is preferable for children to watch instructive and educational TV programs or enjoy computer games and Internet for an appropriate period of time rather than being completely prevented from using the television or computer even in the absence of their parents.

### DISCLOSURE OF INVENTION

Accordingly, the present invention is directed to a device for limiting the use of electronic appliances that substantially obviates one or more problems due to limitations and disadvantages of the related art.

An object of the present invention is to provide a device for limiting the use of electronic appliances which controls the use of electronic appliance such as a television or personal computer but allows any of their users to be able to freely use it only for a specific period of time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a device for limiting the use of electronic appliances includes a timer for limiting the use of a television or personal computer, set inside the television or computer.

### BRIEF DESCRIPTION OF THE DRAWINGS

Further objects and advantages of the invention can be more fully understood from the following detailed description taken in conjunction with the accompanying drawings, in which:

FIG. 1 is a perspective view of a television to which the present invention is applied;

FIG. 2 is a perspective view of a computer to which the present invention is applied;

FIG. 3 is a plan view of a system remote control and a timer-dedicated remote control of the present invention;

FIG. 4 is a block diagram of the device of limiting the use of electronic appliances of the present invention;

FIG. 5 illustrates time setting of the timer according to the present invention;

FIG. 6 is a flow diagram of the operation of the television to which the present invention is applied; and

FIG. 7 is a flow diagram of the operation of the computer to which the present invention is applied.

### BEST MODE FOR CARRYING OUT THE INVENTION

Reference will now be made in detail to the preferred embodiments of the present invention, examples of which are illustrated in the accompanying drawings.

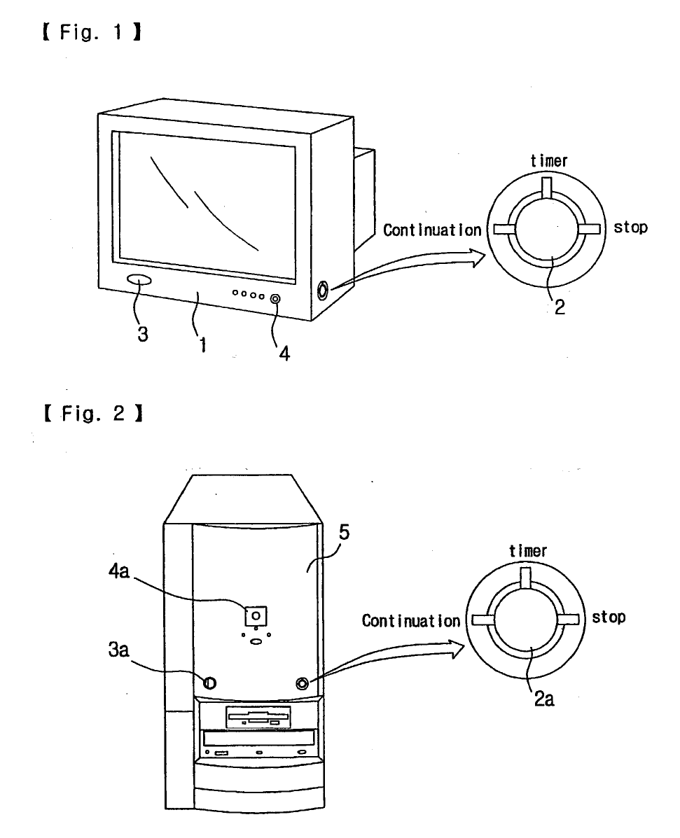

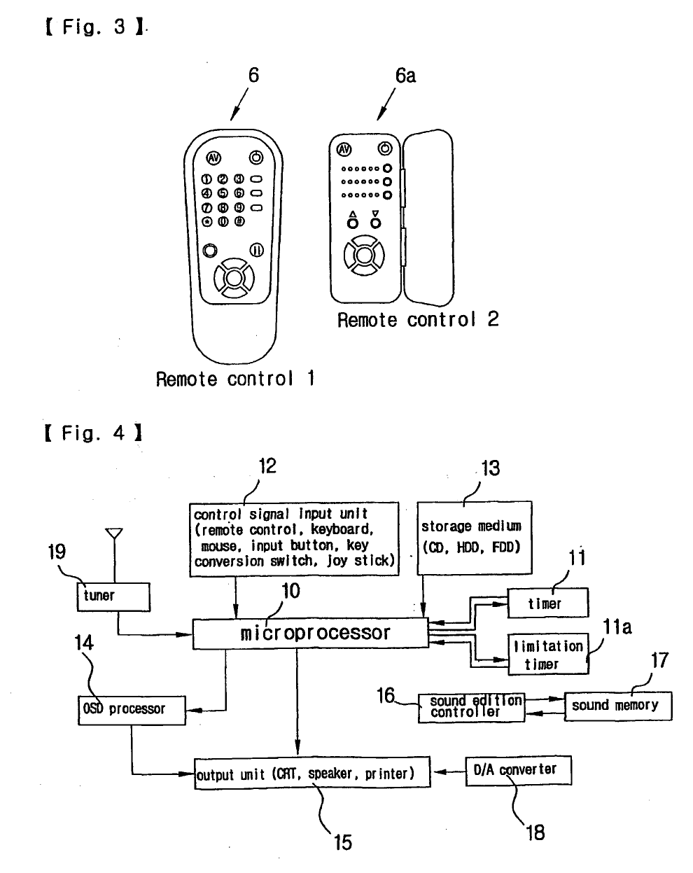

A device for limiting the use of electronic appliances according to the present invention includes a timer for limiting the use of electronic appliances that is set inside a television shown in FIG. 1 and a personal computer 5 shown in FIG. 2. Further, the device has a three-stage switch capable of selecting one of continuous use mode, timer mode and stop mode set on the television 1 and computer 5.

Referring to FIGS. 1 to 4, the device for limiting the use of electronic appliances includes a remote control receiver 3(3a) set on the front of the main body of an electronic appliance such as the television 1 or personal computer 5, a timer-dedicated remote control 6a for transmitting a remote control signal to the remote control receiver 3(3a) to select one of the three modes (continuous use mode, timer mode and stop mode) with respect to the electronic appliance, and a limitation timer 11a, set inside the electronic appliance, for setting a period of time for which the electronic appliance will be used when the timer-dedicated remote control 6a selects the timer mode. The device further includes a microprocessor 10 for operating the electronic appliance according to the current time and a predetermined set time of the limitation timer 11a when the timer-dedicated timer 6a selects the timer mode and for displaying the current time and the set time, and a warning means for transmitting a completion warning signal when the electronic appliance is on the verge of completion of its operation in case where the electronic appliance is driven in the timer mode, to normally finish the operation of the appliance.

A key holder for the three-stage conversion switch is set on the electronic appliance, and a dedicated key is inserted into the key holder to select one of the three modes.

The limitation timer is set separately from a timer for setting the current time, and its time setting is carried out by the timer-dedicated remote control or key lock.

The timer is set in a manner that a cursor is moved to input numerals for setting a time on an OSD screen that displays time set for a week, and the time set for a week is repeated.

The three-stage conversion switch of the present invention is set on the television 1 or one of the CRT or main body of the computer 5. The switch can be controlled by a three-stage conversion switch 2 or 2a according to a key lock or the remote control receiver 3(3a) separately set. It is also possible to use a remote control receiver previously set on the television instead of the remote control receiver 3 separately set.

The three-stage conversion switch 2(2a) according to the key lock can be set on the lower or upper part of the front side or side of the television 1 or computer 5 as shown in FIGS. 1 and 2. Without regard to the set position, the switch can select one of the continuation, timer and stop modes using the key.

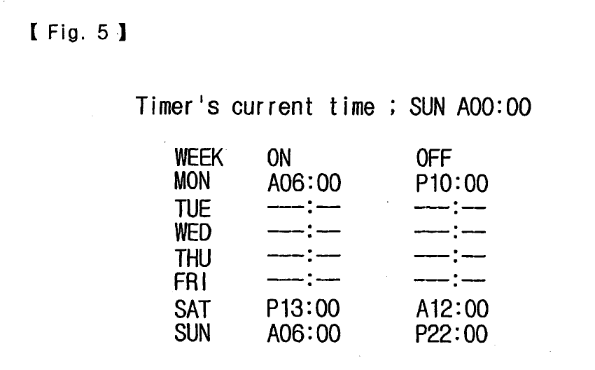

To control the three-stage conversion switch according to the remote control receiver 3, the small-size timer-dedicated remote control 6a is prepared, separately from the system remote control 6, as shown in FIG. 3, in case of the television. With the personal computer 5, only the timer-dedicated remote control 6a is used but a channel or volume control key is not needed. The timer-dedicated remote control 6a has a cover for preventing the remote control from being damaged or abnormally operated so that its user can conveniently carry it with him.

The limitation timer 11a is set inside the television 1 or personal computer 5 and its operation is controlled by the timer-dedicated remote control 6a or the keyboard of the personal computer. The limitation timer 11a can set a time and change a set time only when the key is being inserted into the three-stage conversion switch holder 2 in case of the three-stage conversion switch according to the key lock. The current time of the limitation timer 11a can be set separately from the current time according to the system timer 11 set inside the electronic appliance. The current time of the computer 1 can be changed by anyone so that the computer can be used without regard to the set time of the timer if the current time of the computer is varied. Accordingly, the current time of the limitation timer 11a is set separately from the current time set by the system timer 11 for the purpose of keeping children from changing a set time of the timer 11a in order to indiscreetly watch the television or use the personal computer.

Referring to FIG. 4, the microprocessor 10 recognizes signals sent from a control signal input unit 12, a tuner 19 and a storage medium 13 to control an OSD processor 14, a sound edition controller 16 and an output unit 15. The control signal input unit 12 may includes a remote control, a keyboard, a mouse and a joy stick, and the storage medium 13 may be a CD, a hard disk or a floppy disk.

The microprocessor 10 controls the OSD processor 14 and the output unit 15 according to a signal sent from the control signal input unit 12 to set a time of the timer, or controls the sound edition controller 16 based on the set time of the timer to allow a sound signal stored in a sound memory 17 to be transmitted through a D/A converter 18 to the output unit 15.

The three-stage conversion switch 2(2a) according to the key lock and the timer-dedicated remote control 6a can be operated only when a power switch 4 or 4a of the television 3 or personal computer 5 is being turned on, to select one of the continuation, timer and stop modes. The microprocessor 10 recognizes a selected mode to store it.

In case where the timer-dedicated remote control 6a selects the timer mode, a timer time setting table is displayed on the screen of the television or computer monitor, as shown in FIG. 5, to allow its user to set ON/OFF time for each day of the week. This set time corresponds to a period of time for which the electronic appliance can be used. Thus, the ON/OFF time can be set in consideration of a period of time for which children or juveniles can be allowed to watch TV or use the computer.

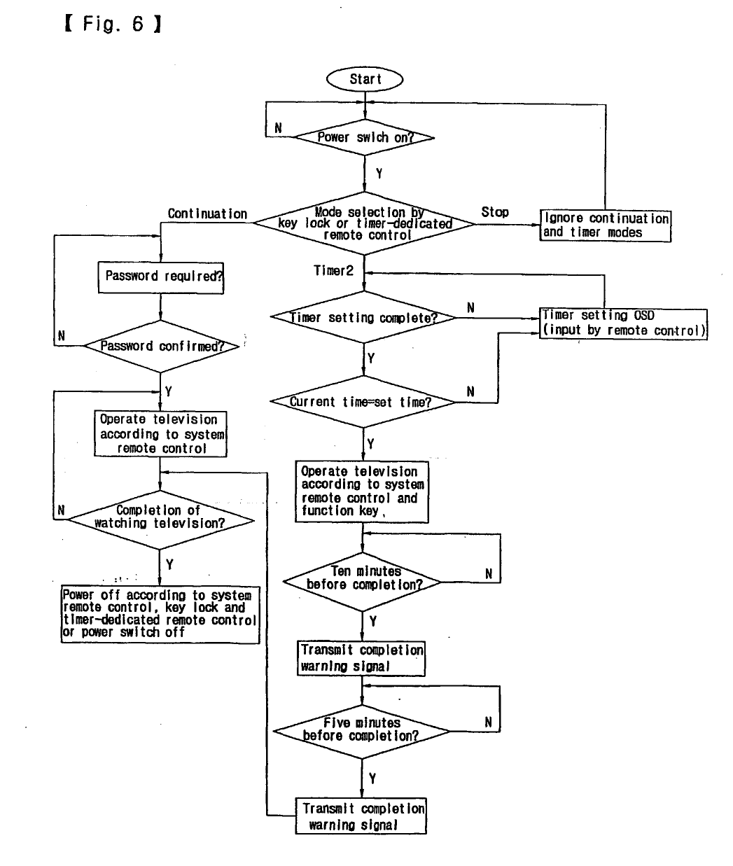

There is described below a procedure of limiting watching the television 1 using the three-stage conversion switch 2 according to the key lock and the timer-dedicated remote control 6a in accordance with an embodiment of the present invention with reference to FIG. 6.

While the power switch 4 of the television 1 is being turned on, one of the continuation, timer and stop modes is selected by using the three-stage conversion switch 2 or timer-dedicated remote control 6a. In case of the selection of continuation mode, the television can be operated according to the system remote control 6. Here, if a password is set, the television can be operated by the system remote control 6 only when the password is judged to be right through a password confirming routine. When its user wants to finish watching the television, he or she turns off the television using power buttons of the system remote control 6, three-stage conversion switch 2 and timer-dedicated remote control 6a or the power switch 4.

In case of the selection of timer mode, it is checked if the timer has been set, and the timer setting OSD is displayed on the screen of the television to guide the user to set the timer. Here, the timer must be set in such a manner that the key is inserted into the three-stage conversion switch 2 according to the key lock to select the timer mode and the timer-dedicated remote control 6a or a function key set a time.

When the timer has been set in the timer mode, the current time and the timer's set time are checked to operate the television by the system remote control 6 and a function key when the current time accords with the set time. The current time and the timer's set time are continuously checked to transmit a completion warning signal (OSD character, image or sound signal) ten minutes and five minutes before the completion of the set time to inform the user that the end of the set time is approaching.

In this case, the user can watch the television only for the period of time set by using the key of the three-stage conversion switch 2 or timer-dedicated remote control 6a. For example, if parents set a period of time for which their children can watch the television and go out having the key of the three-stage conversion switch 2 or the timer-dedicated remote control 6a with them, the children at home can watch the television only for the period of time set by their parents. Accordingly, it is possible to effectively restrict the children's watching TV.

In case of the selection of stop mode, this mode can be selected by the three-stage conversion switch 2 according to the key lock or timer-dedicated remote control 6a while the power switch 4 is being turned on. The power switch 4 is turned off after a predetermined lapse of time after the selection of stop mode. In the stop mode, the entire system of the television 1 is completely turned off so that it is impossible to watch the television.

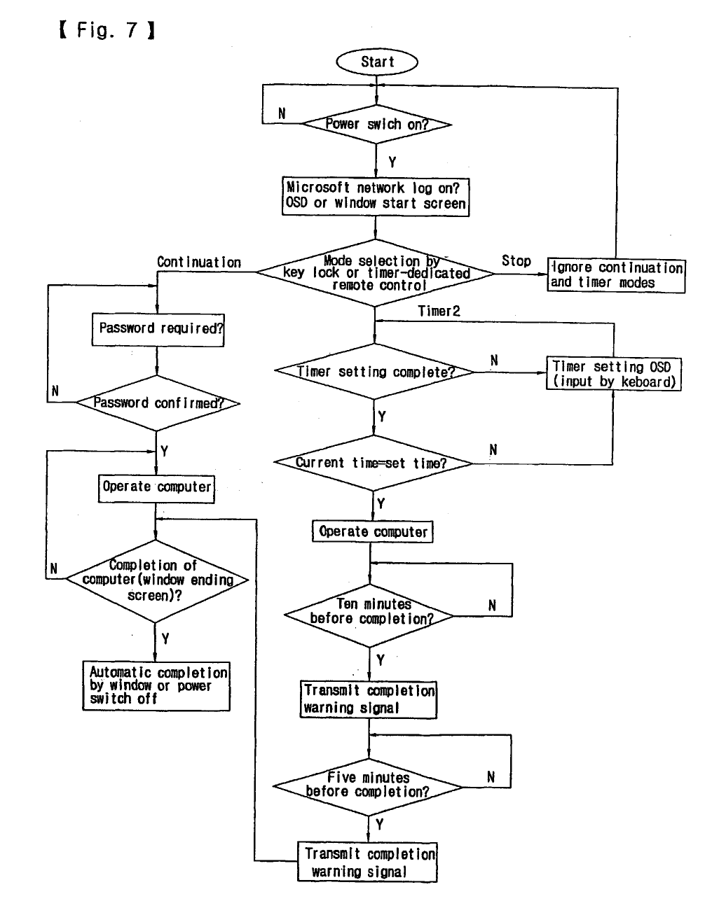

Next, there is described below a procedure of limiting the use of the personal computer 5 according to another embodiment of the invention with reference to FIG. 7.

The operation mode of the timer set inside the computer 5 is selected only by the three-stage conversion switch 2a according to the key lock or timer-dedicated remote control 6a. A period of time for which the computer can be used is set by using the timer-dedicated remote control 6a or the keyboard of the computer after the selection of timer mode.

When the switch 2a or timer-dedicated remote control 6a selects the continuation mode, its user can use the computer without any restriction. In case where a password is set, however, the user must input the password in order to use the computer.

In case of the selection of timer mode, this mode must be selected using the switch 2a or timer-dedicated remote control 6a while the power switch 4a of the computer is being turned on. A period of time for which the computer will be used can be set in the timer mode. In this mode, especially, children can be allowed to use the computer for the set time even in the absence of their parents. The use of the computer is forcibly limited after the lapse of the set time.

In addition, with the completion of the set time approaching, a completion warning signal (OSD character, special image or sound signal) is transmitted ten and five minutes before the end of the set time to inform its user that the completion is approaching. Accordingly, the user can normally finish the computer to prevent data loss in the computer or damage of the system.

In case of the selection of timer mode, children or juveniles can freely use the computer for a predetermined period of time but they are not allowed to use it for a period of time other than the set time in the absence of their parents.

In case of the selection of stop mode, this mode must be selected by using the three-stage conversion switch 2a according to the key lock or timer-dedicated remote control 6a while the power switch 4a is being turned on. The power switch 4a is turned off after a lapse of predetermined time. In this stop mode, especially, the entire system of the computer 5 can be locked so that anyone cannot use the computer.

The present invention provides the three-stage conversion switch according to the key lock and the timer that are capable of selecting one of the continuation, timer and stop modes, and the dedicated key and timer-dedicated remote control capable of operating the switch and the timer, being set inside electronic appliances such as a television and personal computer. The switch and the timer-dedicated remote control allow users to be able to use the electronic appliances only for a predetermined period of time set by the timer but to limit the use of them for a period of time other then the set time. By doing so, children or juveniles can use the electronic appliances only for a predetermined period of time in the absence of their parents.

According to the present invention, parents carry the key or timer-dedicated remote control with them or store it in a specific place after setting a period of time for which the electronic appliances can be used, to effectively restrict the indiscreet use of the electronic appliances in the absence of them. In case where the present invention is applied to the personal computer, especially, security effect can be expected.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

Industrial Applicability

The operation of the limitation timer is controlled by a key lock or timer-dedicated remote control. The continuous use of the electronic appliance, the use of the appliance for a period of time set by the timer, and suspension of the use of the appliance are selected by a three-stage conversion switch. In case of the selection of the use of the appliance for a period of time set by the timer, the electronic appliance can be used only for the period of time set by the limitation timer. During a period of time other than the set time, the electronic appliance may be continuously used or its operation is stopped according to a selected mode.

What is claimed is:

1. A device for limiting the use of electronic appliances, comprising:
a remote control receiver set on the front of the main body of an electronic appliance such as a television or personal computer;
a timer-dedicated remote control for transmitting a remote control signal to the remote control receiver to select one of the three modes (continuous use mode, timer mode and stop mode) with respect to the electronic appliance;
a limitation timer, set inside the electronic appliance, for setting a period of time for which the electronic appliance will be used when the timer-dedicated remote control selects the timer mode;
a microprocessor for operating the electronic appliance according to the current time and a predetermined set time of the limitation timer when the timer-dedicated timer selects the timer mode and for displaying the current time and the set time; and
a warning means for transmitting a completion warning signal when the electronic appliance is on the verge of completion of its operation in case where the electronic appliance is driven in the timer mode, to normally finish the operation of the appliance.

2. The device as claimed in claim 1, wherein a key holder for a three-stage conversion switch is set on the electronic appliance, and a dedicated key is inserted into. the key holder to select one of the three modes.

3. The device as claimed in claim 1, wherein the limitation timer is set separately from a timer for setting the current time, and its time setting is carried out by the timer-dedicated remote control or key lock.

4. The device as claimed in claim 1, wherein the timer is set in a manner that a cursor is moved to input numerals for setting a time on an OSD screen that displays time set for a week, and the time set for a week is repeated.
